(19) United States
(12) Patent Application Publication
(10) Pub. No.: US 2020/0321908 A1
(43) Pub. Date: Oct. 8, 2020

(54) GLAZING ASSEMBLIES WITH INTEGRATED PHOTOVOLTAIC STRUCTURE AND SPACER STRUCTURES FOR SUCH GLAZING ASSEMBLIES

(71) Applicant: PHYSEE GROUP B.V, Delft (NL)

(72) Inventors: Sammy Charley Dave ANDERS, Delft (NL); Ferdinand Lodewijk GRAPPERHAUS, Delft (NL); Drim : STOCKHUIZEN, Delft (NL)

(73) Assignee: PHYSEE GROUP B.V, Delft (NL)

(21) Appl. No.: 16/759,213

(22) PCT Filed: Oct. 29, 2018
(86) PCT No.: PCT/EP2018/079605

§ 371 Date: Apr. 24, 2020

(30) Foreign Application Priority Data
Oct. 27, 2017 (EP) PCT/EP2017/077696

(51) Int. Cl. H02S 20/26; H02S 30/10; H02S 40/36; H02J 3/38; E06B 3/663; E06B 3/667; E06B 7/28

(52) U.S. Cl. CPC H02S 20/26; H02S 30/10; H02S 40/36; H02J 3/381; H02J 2300/26; E06B 3/667; E06B 3/66342; E06B 7/28; E06B 3/66314

(57) ABSTRACT

Glazing assembly are described comprising at least a first (inner) glass pane, a second (outer) glass pane and at least one peripheral spacer structure for providing a predetermined separation between the first and second glass pane, the peripheral spacer structure being positioned at the peripheral area of the first and second glass pane; one or more photovoltaic (PV) cell modules mounted on at least part of the peripheral spacer structure, the one or more PV cell modules being positioned in the space defined by the first and second glass panes and the peripheral spacer structure (inter-pane space); wherein at least part of the peripheral spacer structure comprises one or more mounting members adapted to orient a light receiving surface of PV cells of the PV cell modules in a tilted position with respect to the plane of the second (outer) glass pane.

### FIELD OF THE INVENTION

The invention relates to glazing assemblies and spacer structures for such glazing assemblies, and, in particular, though not exclusively, to a power-generating multi-pane glazing assembly, a window comprising a power-generating glazing assembly, a modular power-generating spacer structure for a multi-pane glazing assembly and a corner connector and an electronic module for such power-generating spacer structure.

### BACKGROUND OF THE INVENTION

Photovoltaics play an important role in transforming buildings into neutral, or net zero, energy consumers. Preferably such building locally produces as much energy as it consumes. Building-integrated photovoltaics (BIPV) are photovoltaic structures that are used to replace conventional building structures in parts of the building envelope such as the roof, skylights, windows or facades. BIPV structures are increasingly being incorporated into the construction as a principal or ancillary source of electrical power and existing structures may be retrofitted with similar technology. This makes BIPV one of the fastest growing segments of the photovoltaic industry.

An example of a building-integrated photovoltaic structure is power-generating window structure that can produce sufficient energy for locally powering peripheral functions such as electronically controlled sunshades, climate control, etc. EP1703063 describes power-generating window structures wherein photovoltaic elements are laminated against vertical surface of the hollow window profile, typically an aluminum, plastic and/or fiberglass profile, in which two or more glass panes are mounted. Alternatively, the photovoltaic elements can be laminated against the glass surface within the inter-pane space, i.e. the space between the window panes in a peripheral area of the structure, in particular, an area close to the peripheral spacer structure that keeps the glass panes separated from each other.

Laminating photovoltaic elements against the glass panes in a peripheral area of such window structure does not allow orienting the photovoltaic elements in such as way so that they can be operated in an optimal way. Shading effects in the peripheral area of the window structure and a relatively large inclination angle between the incoming light and the surface of photovoltaic elements bonded to the surface of the glass panes may cause the photovoltaic elements to perform suboptimal. Further, the lamination of the photovoltaic elements may negatively influence the thermal properties of the window structure. Additionally, thermal effects may cause stress in the photovoltaic elements affecting its overall performance. It further requires the need to integrate the bonding process of the photovoltaic elements in the assembly process of the glazing assemblies.

DE202011102438 provides a high-level description of a double pane glazing assembly including a spacer structure around the periphery of the glazing assembly wherein a photovoltaic module is mounted on the spacer structure within the space between the window panes. It is suggested that the photovoltaic module may be mounted to the spacer structure using a hinge so that the photovoltaic module can be folded out.

The above-referenced prior art documents disregard the fact that mass production of modern high performance multi-pane glazing structures that can be used in e.g. zero-energy buildings and smart building solutions require careful specification of each element in production process to accurately control characteristics such as heat gain losses, transparency (glare), shading, thermal comfort, acoustics, color effects, etc. so that high performance of the glazing structure is guaranteed over a long period (e.g. 10 years or longer). For example, the PV modules require electronics and wiring within the space between the window panes and electronic connections to the outside for both power transportation and data communication. Such external connection forms a potential weak spot in the double-glazing structure. Thus, the suggested PV functionalities of the glazing structures are as such not compatible with the high-volume production processes of modern high-performance multi-pane glazing structures.

Hence, there is a need in the art for improved power-generating spacer structures and glazing assemblies comprising such power generating spacer structures. In particular, there is a need in the art for improved power-generating multi-pane glazing assemblies, which can be easily and flexibly optimized with respect to the amount of light it receives, the specifications of high-end glazing structures and the standardized high-volume manufacture processes of high performance multi-pane glazing assemblies.

### SUMMARY OF THE INVENTION

It is an objective of the invention to reduce or eliminate at least one of the drawbacks known in the prior art.

In an aspect, the invention relates to a glazing assembly comprising: at least a first (inner) glass pane, a second (outer) glass pane and at least one spacer structure for providing a predetermined separation between the first and second glass pane, the spacer structure being positioned at a peripheral area of the first and second glass pane; one or more photovoltaic (PV) modules mounted on and/or in at least part of the spacer structure, the one or more PV modules being positioned in a space defined by the first and second glass panes and the spacer structure (inter-pane space); wherein at least part of the spacer structure comprises one or more mounting members adapted to orient a light receiving surface of PV cells of the PV modules in a tilted position with respect to the plane of the second (outer) glass pane; and, wherein the spacer structure comprises one or more elongated members, each elongated member having a cross-sectional profile, the profile defining a hollow body part and a mounting part, the mounting part comprising one or more fastening members for removably mounting the one or more PV cell modules on at least part of the peripheral spacer structure. Thus, the PV modules may be removably mounted onto part of the spacer structure. For example, a sliding and/or a clamping mechanism may be used to mechanically fixate the PV modules to part of the spacer structure.

In an embodiment, the light receiving surface of the one or more PV modules and the surface of the first or second pane define a tilt angle between 10 and 80 degrees, more preferably between 20 and 70 degrees, even more preferably between 30 and 60 degrees.

In an embodiment, the mounting part may be configured to orient the one or more PV modules in a fixed tilted position. In another embodiment, the one or more fastening members of the mounting part may be configured to engage with one or more fastening members of the body part for removably mounting the mounting part comprising the one or more PV modules onto the body part. Thus, the mounting part may be used as a submount to mount the PV modules to the body part of the spacer structure.

In an embodiment the (hollow) body part may have a substantially rectangular shaped cross-section. In another embodiment, the mounting part may have a triangular shaped cross-section. In yet another embodiment, the mounting part having a right triangular shaped cross-section, wherein the side opposite the right angle forming a tiled mounting surface for the one or more PV modules and wherein, optionally, a side adjacent to the right angle forming a mounting area for mounting the mounting part onto the hollow body part.

In an embodiment, the spacer structure may further comprise a first elongated member for fixating one or more first PV modules in a first titled position, a second elongated member for fixating one or more second PV modules in a second titled position and a corner connection for mechanically connecting a first end of the first member to a first end of the second member.

In an embodiment, the corner connector may include a main body connected to a first end portion and a second end portion, the first end portion comprising at least a first leg which is shaped to engage with a first end of the first member to provide a first mechanical connection, preferably a first sliding connection, and the second end portion comprising at least a second leg which is shaped to engage with a first end of the second member to provide a second mechanical connection, preferably a second sliding connection.

In an embodiment, the corner connection further comprises at least one electrical wiring structure, wherein the at least one electrical wiring structure is arranged to electrically connect one of the one or more first PV modules mounted on the first member to a controller module, preferably a maximum power point tracking (MPPT) module, arranged in and/or mounted on a part of the second member.

In another embodiment, the at least one electrical wiring structure may comprise electrical leads embedded in the main body of the corner connector, a first end of the electrical leads may form a first power connector in the inter-pane cavity of the glazing assembly and a second end of the electrical leads forming a second power connector outside the inter-pane cavity.

In an embodiment, at least one at least one wiring structure may comprise one or more (flexible) printed circuit boards or (flexible) printed wiring boards.

In an embodiment, the spacer structure may comprise a first bonding surface for bonding a first glass pane and a second bonding surface for boding a second glass pane, the spacer structure forming or being part of a seal, preferably a hermetic seal, along the peripheral part of the first and second glass pane, the seal sealing the space between the first and second glass pane (the inter-pane cavity).

In an embodiment, the second glass pane may include a central window area which is transparent for solar light from the visible part of the spectrum and which reflects at least part of the (near) infrared part of the solar spectrum and peripheral area around the central window area, the peripheral area defining a solar cell light entrance area for exposing the PV cells to solar light from the visible and the (near) infrared part of the spectrum, preferably the central window area being covered with one or more (near) infrared reflecting thin-film coatings and the peripheral area not being covered with the one or more (near) infrared reflecting thin-film coatings.

In an embodiment, at least part of the one or more PV modules may comprise an elongated shaped electrical wiring board, preferably a printed circuit board (PCB), comprising a first outer edge and an opposite second outer edge, the electrical wiring board including an electrical wiring structure arranged to electrically connect at least part of the PV cells of the PV module in series.

In an embodiment, the electrical wiring structure may further comprise a first PV contact at the first outer edge and a first PV contact at the second outer edge, wherein the first PV contacts are connected to the anode side of the series connected PV cells and wherein the electrical wiring structure includes a second PV contact at the first outer edge and a second PV contact at the second outer edge, wherein the second PV contact is connected to the cathode side of the series connected PV cells.

In an embodiment, the electrical wiring board of the PV module may further comprise a first electrical bus and second electrical bus, the first electrical bus electrically connecting a third contact at the first outer edge with a third contact at the second outer edge and the second electrical bus electrically connecting a fourth contact at the first outer edge with a fourth contact at the second outer edge.

In an embodiment, the first PV modules arranged on a first part of the spacer structure along a first edge of a window pane may be electrically connected to each other, the electrically connected first PV modules forming a first PV array; and, wherein second PV modules arranged on a second part of the spacer structure along a second edge of a window pane may be electrically connected to each other, the electrically connected second PV modules forming a second PV array, wherein at least two maximum power point tracking (MPPT) devices may be arranged on the first part of the spacer structure, the first MPPT device being connected to the first PV array and the second MPPT device being connected to the second PV array.

In a further aspect, the invention may relate to a glazing assembly comprising: at least a first (inner) glass pane, a second (outer) glass pane and at least one peripheral spacer structure for providing a predetermined separation between the first and second glass pane; a plurality of elongated photovoltaic (PV) cell modules positioned along one or more edges of the first and second glass pane, the light receiving surface of the PV cells of the plurality of PV cell modules and the plane of the second (outer) glass pane defining a tilt angle, preferably the tilt angle being selected between 10 and 80 degrees, preferably between 20 and 70 degrees, more preferably between 30 and 60; and, wherein PV cell modules positioned along a first edge of the first and second glass pane are connected to a first maximum power point tracking (MPPT) device and PV cell modules positioned along a second edge of the first and second glass pane are connected to a second maximum power point tracking (MPPT) device.

In a further aspect, the invention may relate to a power-generating spacer structure for a power-generating glazing assembly comprising: one or more photovoltaic (PV) modules mounted on and/or in at least part of a spacer structure for a glazing assembly comprising first and second glass panes, the one or more PV modules being positioned in a space defined by the first and second glass panes and the spacer structure (inter-pane space); wherein at least part of the spacer structure comprises one or more mounting members adapted to orient a light receiving surface of PV cells of the PV modules in a tilted position with respect to the plane of the second (outer) glass pane; and, wherein the spacer structure comprises one or more elongated members, each elongated member having a cross-sectional profile, the profile defining a hollow body part and a mounting part, the mounting part comprising one or more fastening members for removably mounting the one or more PV cell modules on at least part of the peripheral spacer structure.

In an embodiment, the light receiving surface of the one or more PV modules and the surface of the first or second pane may define a tilt angle between 10 and 80 degrees, more preferably between 20 and 70 degrees, even more preferably between 30 and 60 degrees.

In an embodiment, the mounting part may be configured to orient the one or more PV modules in a fixed tilted position. In an embodiment, the one or more fastening members of the mounting part may be configured to engage with one or more fastening members of the body part for removably mounting the mounting part comprising the one or more PV modules onto the body part.

In an embodiment, the hollow body part may have a substantially rectangular shaped cross-section and/or wherein the mounting part has a triangular shaped cross-section, preferably the mounting part having a right triangular shaped cross-section, wherein the side opposite the right angle forming a tiled mounting surface for the one or more PV modules and wherein, optionally, a side adjacent to the right angle forming a mounting area for mounting the mounting part onto the hollow body part.

In an embodiment, the spacer structure may further comprise a first elongated member for fixating one or more first PV modules in a first titled position, a second elongated member for fixating one or more second PV modules in a second titled position and a corner connection for mechanically connecting a first end of the first member to a first end of the second member.

In an embodiment, the corner connector may include a main body connected to a first end portion and a second end portion, the first end portion comprising at least a first leg which is shaped to engage with a first end of the first member to provide a first mechanical connection, preferably a first sliding connection, and the second end portion comprising at least a second leg which is shaped to engage with a first end of the second member to provide a second mechanical connection, preferably a second sliding connection.

In an embodiment, the corner connection may further comprise at least one electrical wiring structure, wherein the at least one electrical wiring structure is arranged to electrically connect one of the one or more first PV modules mounted on the first member to a controller module, preferably a maximum power point tracking (MPPT) module, arranged in and/or mounted on a part of the second member.

In an embodiment, the at least one electrical wiring structure may comprise electrical leads embedded in the main body of the corner connector, a first end of the electrical leads forming a first power connector in the inter-pane cavity of the glazing assembly and a second end of the electrical leads forming a second power connector outside the inter-pane cavity, preferably the at least one at least one wiring structure comprising one or more (flexible) printed circuit boards or (flexible) printed wiring boards.

In an embodiment, at least part of the one or more PV modules may comprise an elongated shaped electrical wiring board, preferably a printed circuit board (PCB), comprising a first outer edge and an opposite second outer edge, the electrical wiring board including an electrical wiring structure arranged to electrically connect at least part of the PV cells of the PV module in series, preferably the electrical wiring structure further including a first PV contact at the first outer edge and a first PV contact at the second outer edge, wherein the first PV contacts are connected to the anode side of the series connected PV cells and wherein the electrical wiring structure includes a second PV contact at the first outer edge and a second PV contact at the second outer edge, wherein the second PV contact is connected to the cathode side of the series connected PV cells.

In an embodiment, the electrical wiring board of the PV module may further comprise a first electrical bus and second electrical bus, the first electrical bus electrically connecting a third contact at the first outer edge with a third contact at the second outer edge and the second electrical bus electrically connecting a fourth contact at the first outer edge with a fourth contact at the second outer edge.

In an embodiment, first PV modules arranged on a first part of the spacer structure along a first edge of a window pane are electrically connected to each other, the electrically connected first PV modules forming a first PV array; and, second PV modules arranged on a first part of the spacer structure along a second edge of a window pane are electrically connected to each other, the electrically connected second PV modules forming a second PV array, at least two maximum power point tracking (MPPT) devices arranged on the first part of the spacer structure, the first MPPT device being connected to the first PV array and the second MPPT device being connected to the second PV array.

In an aspect, the invention may relate to a corner connection for a spacer structure, preferably a spacer structure according to any of embodiments described in this application: wherein the corner connection comprises a main body connected to a first end portion and a second end portion, the first end portion comprising at least a first leg which is shaped to engage with a first end of a part of the spacer structure to provide a first mechanical connection, preferably a first sliding connection, with the first part of the spacer structure; and, the second end portion comprising at least a second leg which is shaped to engage with a first end of a second part of the spacer structure to provide a second mechanical connection, preferably a second sliding connection, with the second part of the spacer structure; and, at least one electrical wiring structure, the wiring structure comprising one or more (flexible) printed circuit boards mounted on the main body, preferably a first edge of the printed circuit board including a first electrical connector and a second edge of the printed circuit board including a second electrical connector; and, the wiring structure comprising electrical power leads embedded in the main body of the corner connector, a first end of the electrical leads forming a first power connector in an inter-pane cavity of a glazing assembly and a second end of the electrical leads forming a second power connector outside the inter-pane cavity; wherein electrical path of the one or more (flexible) printed circuit boards or (flexible) printed wiring boards is in electrical contact with the electrical power leads.

In an aspect, the invention may relate to a glazing assembly comprising: at least a first (inner) glass pane, a second (outer) glass pane and at least one peripheral spacer structure for providing a predetermined separation between the first and second glass pane, the peripheral spacer structure being positioned at the peripheral area of the first and second glass pane; one or more photovoltaic (PV) cell modules mounted on and/or in at least part of the peripheral spacer structure, the one or more PV cell modules being positioned in the space defined by the first and second glass panes and the peripheral spacer structure (inter-pane space); wherein at least part of the peripheral spacer structure comprises one or more mounting members adapted to orient a light receiving surface of PV cells of the PV cell modules in a tilted position with respect to the plane of the second (outer) glass pane. Hence, the invention provides a power-generating glazing assemblies wherein PV cell modules are mounted in a tilted position on the peripheral spacer structure. The tilted position orients the light receiving faces of the PV cells of the PV cell modules towards the outer glass pane of the glazing assembly. This way, the PV cell modules can be optimally oriented with respect to the sun without affecting the thermal properties of the glazing assembly. As the PV cell modules are mounted on the spacer structure, the spacer structure and the mounted PV cell modules can be manufactured separately.

In an embodiment, the light receiving surface of each of the one or more PV cell modules and the surface of the first or second plane may define a tilt angle between 0 and 90 degrees, preferably between 10 and 80 degrees, more preferably between 20 and 70 degrees, even more preferably between 30 and 60. Hence, PV cell modules may be oriented according to tilt angle. Depending on the geographical orientation where the glazing window is used and/or depending on the place of the glazing window in a building different tilt angles may be used. Moreover, PV cell modules oriented along a first edge of the glazing assembly, e.g. the left vertical edge, may have a different tilt angle when compared to PV cell modules oriented along a second edge of the glazing assembly, e.g. the lower horizontal edge.

In an embodiment, the peripheral spacer structure may comprise a first bonding surface bonded against the first glass pane and a second bonding surface bonded against the second glass pane, the peripheral spacer structure forming or being part of a seal, preferably a hermetic seal, along the peripheral part of the first and second glass pane, the seal sealing the space between the first and second glass pane. In this embodiment, the surfaces of the spacer structure may be used to bond or glue the glass panes. This way, a bonding structure along the peripheral area of the glass panes may be formed which may server a seal for sealing the space (the inter-pane space), i.e. the space between the glass panes and the spacer.

In an embodiment, the peripheral spacer structures may be shaped as an elongated tube having a predetermined cross-sectional profile. In an embodiment, the profile may define a body part, preferably a hollow body part, and a mounting part comprising one or more fastening members for removably mounting the one or more PV cell modules on at least part of the peripheral spacer structure. Hence, the spacer structure may include a metal (extruded) elongated tube, non-metal, e.g. elongated tube, or elongate tube structure which is made of both metal and non-metal materials.

In an embodiment, the one or more fastening members may include at least two clamping members for clamping a PV cell module in position. In an embodiment, the one or more fastening members may include at least two sliding members which are configured to engage with the edge of a support substrate of the PV cell module. Hence, the PV cell modules may be mounted on the spacer structure using a mechanical mechanism, e.g. clamping or sliding. Such mounting structures allow sufficient thermal expansion of the different materials so that deteriorating effects due to thermal stress can be minimized.

In an embodiment, the second glass pane may include a window area which is transparent for solar light from the visible part of the spectrum and which reflects at least part of the (near) infrared part of the solar spectrum. In an embodiment, the second glass pane may include a peripheral area around the central area, wherein the peripheral area may define a solar cell light entrance area for exposing the PV cells to solar light from the visible and the (near) infrared part of the spectrum. In an embodiment, the window area may be covered with one or more (near) infrared reflecting thin-film coatings and wherein the peripheral area is not covered with the one or more (near) infrared reflecting thin-film coatings. Conventional glass panes often include infrared reflection coatings. In this embodiment, the peripheral areas in the glass pane do not comprise such infrared reflection coating. This way the PV cells may be exposed to a substantial part (including the infrared part) of the solar spectrum.

In an embodiment, the one or more photovoltaic (PV) cell modules may be oriented to receive visible and (near) infrared light via the peripheral area. Hence, in that case PV modules are directly exposed to solar light that enters the windows via the peripheral area. In another embodiment, visible light that has entered the glazing assembly via the window area may be trapped within the area between the glass panes by total internal reflection and towards the one or more photovoltaic (PV) cell modules. Hence, in this embodiment, at least part of the light of the solar spectrum, including UV, visible and (near) infrared, that enters the window area of the glazing assembly may be captured via total internal reflection and indirectly expose the PV cell modules. Hence, in this embodiment, the multi-pane glazing assembly is used as a light guide to guide light from the window area towards PV cell modules in the peripheral area.

In an embodiment, a photovoltaic (PV) cell module may comprise an elongated shaped support substrate, preferably a printed circuit board (PCB) including an array of electrically connected photovoltaic cells mounted thereon.

In an embodiment, a PV cell module may include or may be connected to an inverter.

In an embodiment, PV cell modules arranged along an edge of a window pane may be electrical connected to each other, wherein the electrically connected PV cell modules may form an PV array. In an embodiment, a maximum power point tracking (MPPT) device may be connected to the PV array, the MPPT device being configured to optimize the power transfer efficiency of the PV array. In an embodiment, each PV array may be connected to a separate MPPT device. Hence, in these embodiments, each PV array may be controlled by a separate MPPT device.

In a further aspect, the invention may relate to a glazing assembly comprising: at least a first (inner) glass pane, a second (outer) glass pane and at least one peripheral spacer structure for providing a predetermined separation between the first and second glass pane; a plurality of elongated photovoltaic (PV) cell modules positioned along one or more edges of the first and second glass pane, the light receiving surface of the PV cells of the plurality of PV cell modules and the plane of the second (outer) glass pane defining a tilt angle

In an embodiment, the tilt angle may be selected between 10 and 80 degrees, preferably between 20 and 70 degrees, more preferably between 30 and 60.

In an embodiment, one or more first PV cell modules positioned along a first edge of the first and second glass pane and oriented in a first tilted position may be connected to a first maximum power point tracking (MPPT) device and one or more second PV cell modules positioned along a second edge of the first and second glass pane and oriented in a second tilted position may be connected to a second maximum power point tracking (MPPT) device. Alternatively, the one or more first and second PV cell modules positioned along a first and second edge may be connected to a maximum power point tracking (MPPT) device which is configured to executed a first maximum power point tracking process for optimizing the power point of the one or more first PV cell modules and a second maximum power point tracking process for optimizing the power point of the one or more second PV cell modules. Hence, PV modules positioned along the left-vertical, bottom-horizontal and right-vertical edge, oriented at three different angles, may be individually optimized using a maximum power point tracking (MPPT) device.

In an embodiment, the peripheral spacer structure for a power-generating glazing assembly may comprise: an peripheral spacer profile, preferably an extruded elongated spacer profile, the profile comprising a body part, preferably a hollow body part, and a mounting part, the body part including a first bonding surface for receiving a first glass pane and a second bonding surface for receiving a second glass pane; and, the mounting part including one or more fastening members for removably mounting one or more PV cell modules on the spacer profile, the one or more fastening members being adapted to orient a light receiving surface of a PV cell module in a tilted position with respect to the plane of the second (outer) glass pane.

In an embodiment, the one or more fastening members include at least two clamping members for clamping a PV cell module in position and/or wherein the one or more mounting members include at least two sliding members which are configured to engage with the edge of a support substrate of the PV cell module.

In an embodiment, a plurality of photovoltaic (PV) cell modules are mounted on the spacer profile. In an embodiment, a PV cell module may comprise an elongated shaped support substrate, preferably a printed circuit board (PCB), including an array of electrically connected photovoltaic cells mounted thereon.

In a further aspect, the invention relates to a window comprising a glazing assembly according to any of the embodiments described above.

The invention will be further illustrated with reference to the attached drawings, which schematically will show embodiments according to the invention. It will be understood that the invention is not in any way restricted to these specific embodiments.

### BRIEF DESCRIPTION OF THE DRAWINGS

FIG. 1 depicts at least part of a power-generating glazing assembly according an embodiment of the invention;

FIG. 2 depicts a cross-sectional view of a peripheral spacer structure for use in a glazing assembly according to an embodiment of the invention;

FIGS. 3A and 3B depict cross-sectional views of a power-generating glazing assembly according to various embodiment of the invention;

FIG. 4A-4C depict part of a peripheral spacer structure according to various embodiments of the invention;

FIGS. 5A and 5B depict a further realization of a glazing assembly according to an embodiment of the invention;

FIGS. 6A and 6B depict a joint structure for a modular power-generating peripheral spacer structure

FIGS. 7A and 7B depict a joint structure for a modular power-generating peripheral spacer structure

FIGS. 8A and 8B depict a right corner section of a power-generating spacer structure according to an embodiment of the invention.

FIGS. 9A and 9B depict a left corner section of a power-generating spacer structure according to an embodiment of the invention.

FIGS. 10A and 10B depict schematics of power-generating glazing assemblies controlled by maximum power point tracking modules according to various embodiments of the invention.

FIG. 11 depicts electronics module for controlling a power-generating spacer structure according to an embodiment of the invention.

FIG. 12 depicts an electrical scheme for a power-generating spacer structure according to an embodiment of the invention.

FIG. 13 depicts an electrical scheme for a power-generating spacer structure according to an embodiment of the invention.

FIG. 14 depicts of a multi-point power tracking module for controlling a power-generating window structure according to an embodiment of the invention;

FIGS. 15A and 15B illustrates the performance of differently controlled power-generating window structures.

### DETAILED DESCRIPTION

In this disclosure, improved power-generating glazing assemblies, in particular multi-pane glazing assemblies are described wherein PV cell modules are positioned and oriented within the cavity that is formed by two glass panes and a peripheral spacer structure, i.e. a spacer structure that is positioned in the peripheral area of the glass panes in order to keep the glass panes at a predetermined distance from each other. The PV cells are mounted onto the peripheral spacer structures such that the orientation of the light receiving surfaces of the PV cell modules are tilted towards the glass pane that functions as the outer glass pane. By mounting the PV cells directly on the peripheral spacer structure and orienting the PV cell modules in a tilted manner along the peripheral areas of the glass panes, the performance of the PV cells can be optimized without affecting the thermal properties of the glazing assembly. The glazing assemblies according to the invention thus include a peripheral spacer structure which fixates the distance between glass panes while at the same time positions the PV cell modules in a tilted position towards the outer glass plane. Hereunder, the advantages of the invention are described in more detail with reference to the figures.

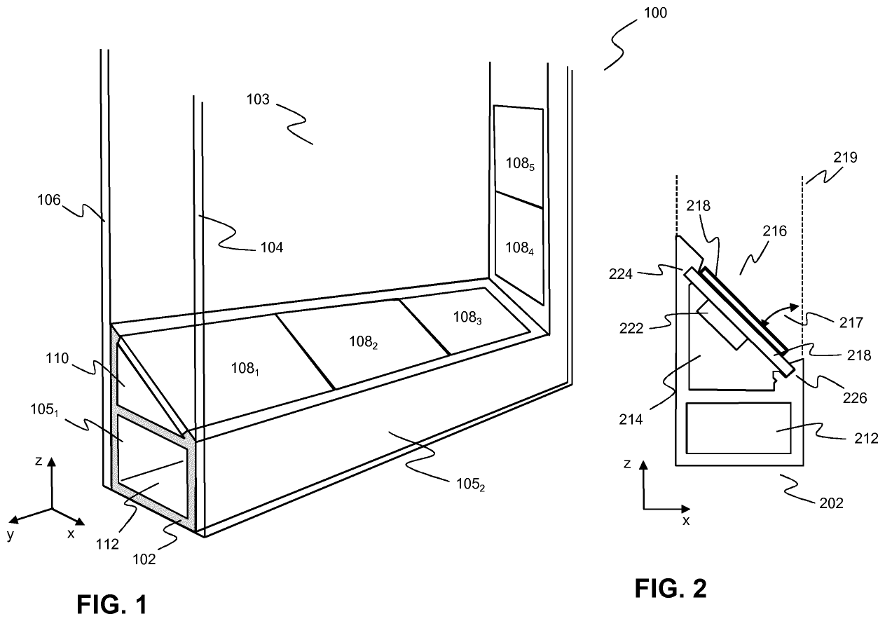

FIG. 1 depicts at least part of a power-generating glazing assembly according an embodiment of the invention. In particular, FIG. 1 depicts a power-generating multi-pane glazing assembly 100 comprising a peripheral spacer structure 102 along the peripheral areas of a first and second glass pane 104,106 (in FIG. 1, the surface plane of the glass panes coincides with the y-z plane). The glazing assembly may further include a central transparent window area 103.

The peripheral spacer structure may form an elongated peripheral spacer structure formed along the peripheral areas of all sides of the window panes in order to fixate the two glass panes at a predetermined distance from each other. The peripheral spacer structure includes mounting members for positioning multiple PV cell modules in a tilted manner along the peripheral areas of the multi-pane glazing assembly. The PV cells modules are mounted such that the light receiving areas of the PV cells are tilted towards the outer glass pane.

Different materials may be used to form the peripheral spacer structure. For example, in an embodiment, the spacer structure may be a hollow metal spacer structure. Suitable materials include e.g. aluminum, stainless steel, or galvanized steel. A metal spacer may have high thermal conductivity, which may reduce the energy-saving benefits of multiple panes, gas fills, and insulating frames. In another embodiment, a non-metal spacer structure may be used. Such non-metal spacer structure may provide improved thermal performance. Suitable materials for such non-metal spacer structure include a composite, a structural foam (e.g. EPDM or silicone foam) or a thermoplastic material. In further embodiments, the spacer structure may include both metal and non-metal materials.

The peripheral spacer structure may be configured to provide a spacing between at least two glass panes, a first (inner) glass pane 104 and a (second) outer glass pane 106. The spacer structure may include bonding surfaces, a first bonding surface 105₁ for bonding an inner glass plane and a second bonding surface 105₂ for bonding an outer glass pane using a suitable bonding agent. The peripheral spacer structure may bond the glass panes at the peripheral area, e.g. the edges, of the (typically rectangular) glass panes. In an embodiment, the peripheral spacer structure may form or may be part of a sealing structure for sealing, preferably hermetically sealing, the inter-pane space, i.e. the space between the glass panes. In some embodiments, the space between the glass panes may be filled with a certain gas, e.g. Argon or Krypton, in order to increase the thermal and/or acoustic insulation.

The spacer structure 102 may be structured as an (extruded) tube having a predetermined cross-sectional profile as shown FIG. 1, including a body part 112, e.g. a hollow body part, and a mounting part 110 for removably mounting one or more photovoltaic (PV) modules 108₁₋₅. As the hollow body part forms a base of the spacer structure this part may also be referred to as a base part. As shown in FIG. 1, the mounting part of the peripheral spacer structure may include one or more mounting members which are adapted to position the PV modules under an angle inside the space between the two glass panes so that the light receiving surfaces of the PV modules are tilted towards the outer glass pane. The tilt angle may be selected to have a value so that the light-receiving surface of the PV cells are tilted towards the outer glass pane in order to optimize the reception of solar light and to avoid shading effects. In an embodiment, the tilt angle may be selected based on the geographical location, e.g. the latitude, of the building in which the glazing assemblies are used. In a further embodiment, the tilt angle of the spacer structure at one side of the glazing assembly may differ from the tilt angel of the glazing assembly of another side of the glazing assembly. This way glazing assemblies may be optimized for use in different orientations, e.g. on the north side or south side of a building. The PV cell modules are mounted onto the spacer structure. This way, the spacer structure and the PV cell modules may be fabricated separately, i.e. before the spacer structure is bonded to the glass panes.

FIG. 2 depicts a cross-sectional view (the z-x plane) of a peripheral spacer structure for a power-generating glazing assembly according to an embodiment of the invention. In particular, FIG. 2 comprises a peripheral spacer structure 202 including a base part 212, e.g. a (hollow) rectangular base part, and a mounting part 214 for mounting a PV cell module 216 under a tilt angle 217 with the plane 219 of the glass panes. A PV cell module or in short, a PV module, may include (an array of) photovoltaic cells 218 mounted on a printed circuit board (PCB) 220. Further, electronic components 222 associated with the PV cells, e.g. bypass diodes and other discharge protection electronics, may be mounted on the PCB. The mounting part may comprise a first (inner) fastening member 224 and second (outer) fastening member 226 for mechanically fixating the PV modules to the peripheral spacer structure. Both fastening members may extend in the y-z plane. In an embodiment, the fastening members may be configured as clamping members for clamping the modules in position. In another embodiment, the fastening members may comprise sliding members which engage with the edges of the PCB. The dimensions of the fastening members may be selected such that a certain thermal expansion of the PCB is allowed without causing mechanical stress in the PCB and/or PV cells.

As shown in FIG. 2, the peripheral spacer structures include a first (inner) fastening member that has a flat structure in the y-z plane and includes a back surface to which the inner glass pane can be bonded. It further includes a second (outer) fastening member that has a flat structure in the y-z plane and includes a front surface to which the outer glass pane can be bonded. The fasting members are configured to fixate the modules in a tilted position so that the PV cells are facing the outer glass pane. To that end, the inner fastening member may extend further in the y-direction than the outer fastening member thereby providing a PV module a tilted position. The tilt angel may be selected between 10 and 80 degrees, preferably between 20 and 70 degrees, more preferably between 30 and 60 degrees. In some embodiments, the tilt angle may be selected between 40 and 50 degrees, preferably around 45 degrees. Hence, the peripheral spacer structure depicted in FIGS. 1 and 2 provides an efficient structure for fixing the light receiving surfaces of the PV modules in a tilted position between two (or more) glass panes in a peripheral area of the window. The light receiving surface of the PV cells are tilted towards the outer glass pane so that it will receive more light when compared to prior art solutions. The tilt can be selected based on the application and/or the geographical location the glazing assembly will be used. The peripheral spacer structure allows mounting of the PV modules before the window planes are bonded to the spacer structure.

While the glazing assemblies of FIGS. 1 and 2 are described with reference to a two-pane glazing assembly, it is submitted that a skilled person will understand that the invention may also be used in multi-pane, e.g. three or four pane glazing assemblies. In that case, the peripheral spacer structure includes means for positioning multiple panes at a spaced distance from each other, wherein in the peripheral parts of each of the spaces formed by two window panes one or more tilted PV cells may be arranged.

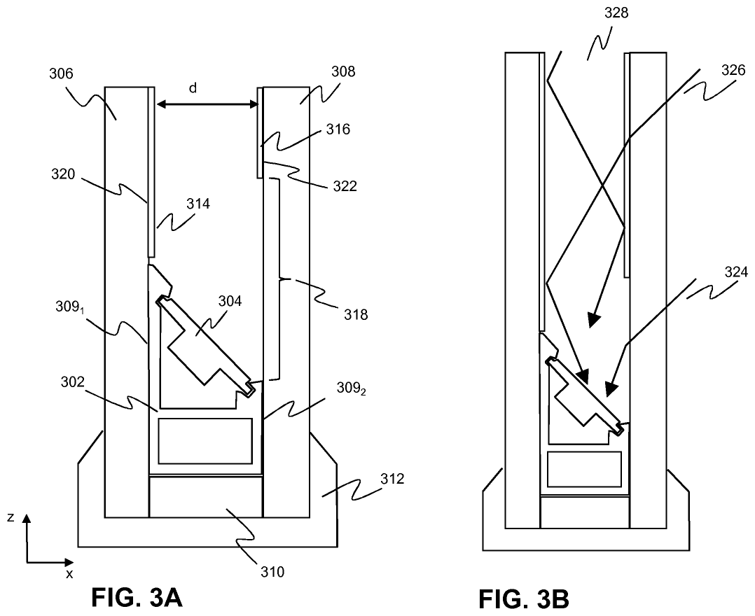

FIGS. 3A and 3B depict cross-sectional views of a power-generating multi-pane glazing assembly according another embodiment of the invention. As shown in FIG. 3A, the multi-pane glazing assembly may include a spacer structure comprising tilted PV modules 304, e.g. a spacer structure 302 as described with reference to FIG. 2. The glass structure may further comprise an inner glass pane 306 and an outer glass pane 308, wherein the peripheral areas (at the edges) of the glass panes are bonded to bonding surfaces 309_{1,2} of the spacer structure so that the parallel surfaces of the glass panes are fixed at a predetermined distance d. The bonding may provide a first seal for sealing the space between the two glass panes. Here, d may be selected such that the thermal properties of the glazing structure is optimized, e.g. such that convention in the space between the glass panes is eliminated or at least minimized. The spacer distance d may be selected between 3 and 30 mm, preferably 5 and 25 mm, more preferably between 10 and 20 mm. A seal 310 at the edge of the glass panes may provide a second seal for sealing the space between the two glass panes. Further, a sash 312 may keep the glazing assembly that includes the spaced glass panes in place.

In this particular embodiment, the glass panes may include one or more optical thin-film layers 314,316 provided over a substantial part of the surface the glass pane, in particular the inner surface of the glass panes, i.e. the surfaces that are located within the space between the glass panes. At least one of the optical layers may comprise a (near) infrared reflector. Such infrared reflector may be configured as a dielectric mirror, a dichroic filter, which reflects (near) infrared light, while allowing visible light to pass. The thin-film (near) infrared radiation reflection coating may be arranged over the window part of the glass panes. Preferably, the inner surface 322 of the outer glass pane 308 may be provided with a thin-film (near) infrared radiation reflection coating 316.

As shown in FIG. 3A, the inner surface 320 of the inner glass pane 306 may be covered with a first (near) infrared radiation reflector 314 and/or the inner surface 322 of the outer glass pane 308 may be covered with a second (near) infrared radiation reflector 316.

In an embodiment, the surface of the outer glass pane may include a central (window) part and a peripheral part 318 arranged around the central part. The central (window) part may be provided with a reflective infrared coating so that it is transparent for visible light but reflective for (near) infrared light. In contrast, the peripheral part is not covered by a reflective infrared coating. Hence, the peripheral part of the glass pane, provides a window that is transparent for both visible and (near) infrared light so that the PV cells are exposed to the whole solar spectrum.

Typically, glass panes include one or more optical coatings that include a reflective infrared coating. Hence, in an embodiment, during the assembly of a glazing assembly according to the invention, the reflective infrared coating in the peripheral part of the glass pane, typically a strip of approximately 40-80 mm, may be removed using a suitable process, e.g. an etching process and/or a grinding/polishing process. Alternatively, during the production of the glass panes a masking technique may be used to prevent application of a reflective infrared coating in the peripheral parts of the window panes.

FIG. 3B depicts the exposure of the PV cell modules by solar light. As shown in this figure, the PV cell will be exposed by solar light 324 that enters the peripheral part of the outer window pane. Since the peripheral part does not include a (near) infrared reflective coating, the PV cell will be exposed by radiation from the visible and the infrared part of the solar spectrum. Additionally, the PV cells will be exposed by light that enters the glazing assembly in a central part. Light 326, in particular visible light, that enters the central part under a certain angle will become trapped by total internal reflection in the inter-pane space 328 of the glazing assembly. This light will be guided via total internal reflection towards the peripheral part and absorbed by the PV cells. Hence, in this case, the double pane glazing assembly is used as a waveguide to guide light that is trapped between the glass panes towards the peripheral part.

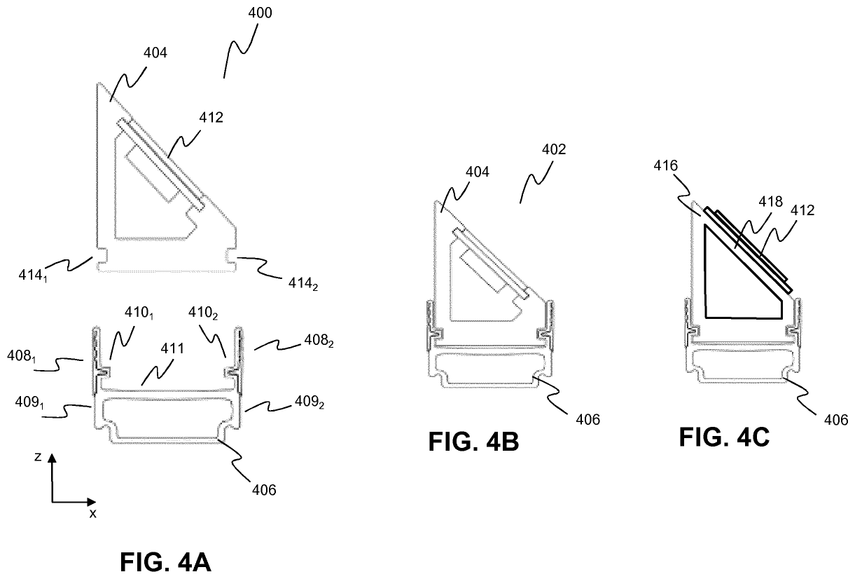

FIG. 4A-4C depict cross-sectional views of parts of a spacer structure according to various embodiments of the invention. In particular, FIGS. 4A and 4B depict a spacer structure 400,402 for a power-generating multi-pane glazing assembly. FIG. 4A illustrates the spacer structure 400 in its disassembled state. The spacer structure may be shaped as an elongated tube having a predetermined cross-sectional profile, wherein the profile defines a hollow body part and a mounting part. The base part 406 and a mounting part 404, in this particular embodiment a separate mounting part, may be configured to mount one or more PV modules 412 in a tilted position within the spacing between two window panes. The substantially rectangular base part may include two contact faces 408_{1,2} (parallel the y-z plane) for receiving window panes and a top surface 411 (parallel to the x-y plane) for receiving the mounting part. The base part may further comprise one or more fastening members 408_{1,2} for removably mounting the mounting part onto the base part. In an embodiment, the fastening members may include (at least) two ridges parallel to the contact faces extending in the y-z plane. The parallel ridges may form a U-profile which is configured to receive and fixate the mounting part. The mounting part may include one or more fastening members 414_{1,2} which are configured to engage with the one or more fastening members of the base part. FIG. 4B depicts the spacer structure in its assembled state.

Thus, in this embodiment, the base part and mounting part are separate elements which may assembled into a spacer structure on which PV modules can be mounted and fixated in a tilted position with respect to the surface of the outer window pane using simple sliding and/or clamping mechanisms. This embodiment provides the advantage that the base part and the mounting part can be separately fabricated and optimized for its functions before assembling the individual parts in a spacer structure.

Different variations of the spacer structure according to FIGS. 4A and 4B are possible without departing from the invention. For example, the spacer structure in FIG. 4C includes a base part and a mounting part that is similar to FIGS. 4A and 4B, however in this embodiment, PV modules may be attached to a tilted face 418 of the mounting part using an adhesive.

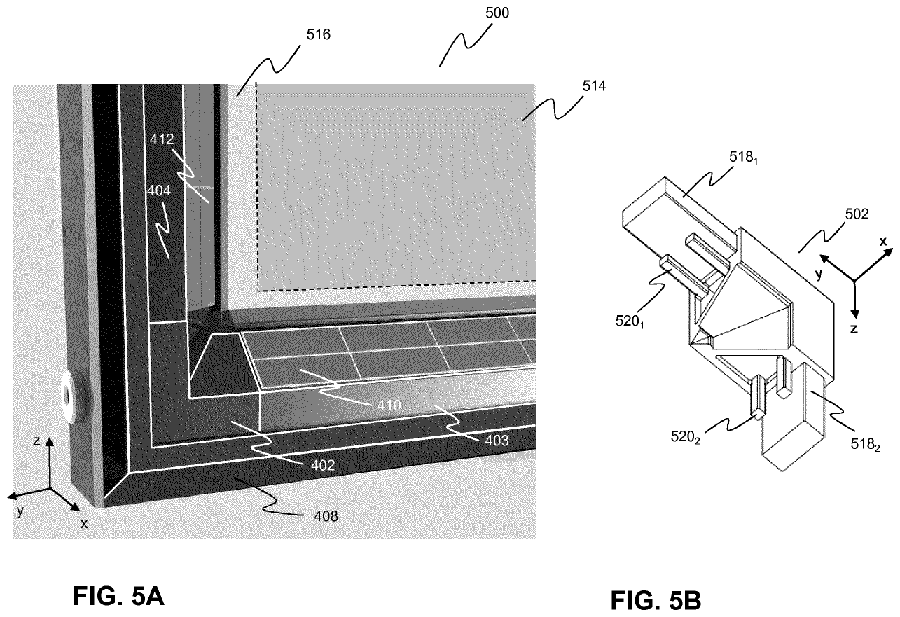

FIGS. 5A and 5B depict a further realization of a glazing assembly according to an embodiment of the invention. FIG. 5A depicts a part of a glazing assembly 500 including a peripheral spacer structure 502,503,504, along a peripheral part of outer glass pane 514 and an inner glass pane (not visible in the figure). As shown, the spacer structure may comprise different elements, including elongated tube structures 503,504 having tilted mounting parts for mounting PV modules and a corner connector structure 502 for connecting the tube structures, e.g. a first elongated tube structure 503 and second elongated (hollow) tube structure 504 along edges of the outer window pane. The cross-section of the elongated tube structure may have a shape as described above with reference to FIG. 1-4. The cross-section shape including a body part (a base of the spacer structure) and a mounting part may provide a mechanically robust spacer structure with excellent sealing and thermal isolation properties.

The elongated PV cell modules 510,512 are mounted onto the mounting part of the spacer structure so that the light receiving faces of the PV cells along a peripheral part of the glass pane are oriented under a tilt angle with the plane of the outer glass pane. Further, a central part 414 of the inner surface of the outer window pane is provided with a (near) infrared reflection coating, so that infrared radiation is reflected. In contract, a peripheral part 416 of the outer glass pane is not provided with a (near) infrared reflection layers so that the tilted PV cells are both exposed to visible and (near) infrared solar radiation.

FIG. 5B depicts a detailed view of a corner connector for mechanically connecting a first elongated (power-generating) spacer structure (e.g. a first elongated (hollow) tube having tilted PV modules mounted thereon) with a second elongate (power-generating) spacer structure (e.g. a second elongated (hollow) tube having tilted PV modules mounted thereon). The first and second end portions of the corner connector may include a plurality of elongated protrusions 518_{1,2}, 520_{1,2} which are arranged to engage with end portions of a spacer structure. Here, in an embodiment, first protrusions 518_{1,2} may form a first and second leg which are shaped to form a sliding connection with the hollow body part of the spacer structure. Similarly, second protrusions 520_{1,2} may be shaped to form a sliding connection with the mounting part of the spacer structure. The elongated protrusions may extend in the longitudinal direction of the tubes (in this case the y and z direction) and form a sliding connection for mechanically connecting the tubes.

As shown in the figure, one or more protrusion 518_{1,2} may be shaped such that a protrusion matches (part of) the shape of the profile of the hollow body part of the spacer structure (e.g. hollow body part 212 as depicted in FIG. 2) and one or more protrusion 520_{1,2} may be shaped such that a protrusion matches (part of) the shape of the mounting part of the spacer structure.

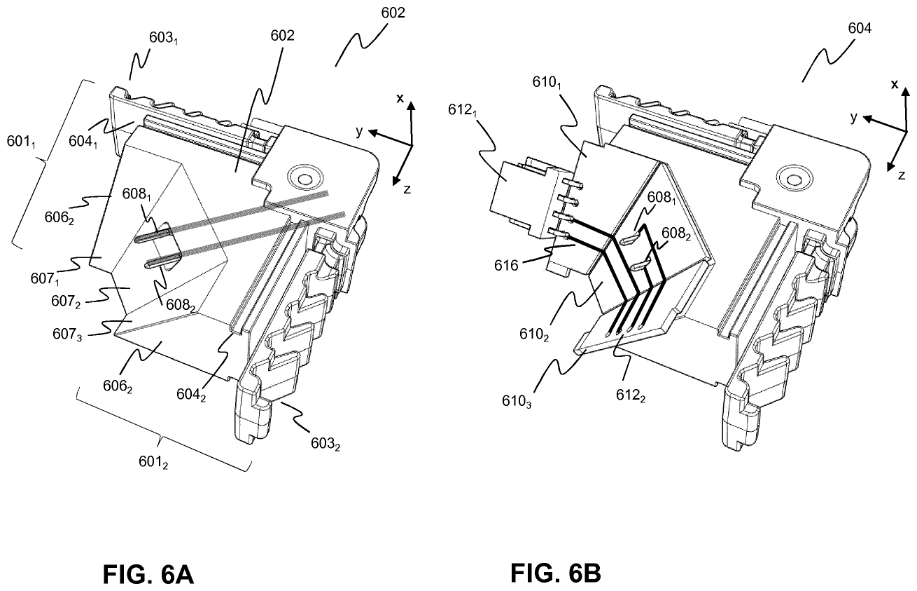

FIGS. 6A and 6B depict a corner connector for a power-generating peripheral spacer structure according to another embodiment of the invention. FIG. 6A depicts a corner connector 602 of a spacer structure comprising a main body 602, preferably a molded main body, first leg 601₁ and second leg 601₂. In an embodiment, the orientation of the first and a second leg may be arranged substantially perpendicular to each other (in this case the y-z plane). In other embodiments, e.g. in case of glazing assemblies having an outer shape that that differs from a rectangular, the orientation between the first and second may be of an angle different that 90 degrees.

A first part 603₁ of the first leg and a first part 603₂ of the second leg may be shaped to fit a part of the profile of the hollow tubular spacer structure, in particular the base part of the hollow tubular spacer structures (e.g. tubular spacer structures having a profile as described with reference to FIG. 1-4 above. A second part 606₁ of the first leg and a second part 606₂ of the second leg may be shaped to fit a part of the profile of the hollow tubular spacer structure, in particular a mounting part of the spacer structure (e.g. the substantially triangular shaped mounting part as depicted in FIG. 1-4 above). Further, the first and second legs may include one or more recesses 604_{1,2} that are configured to engage with corresponding protrusions in the profile of the hollow tubular spacer structure. Alternatively, and/or in addition, the first and second legs may include one or more protrusions that can engage with corresponding recesses in the profile of the hollow tubular spacer structure.

In an embodiment, the shape of the first and second leg and the corresponding shape of the profile of the hollow tubular spacer structure may form a sliding and/or clamping connection for mechanically connecting the tubes.

In an embodiment, the main body of the corner connector may further include first and second electrical (power) leads 608_{1,2} providing an electrical connection between the PV module in the inter-pane cavity and the outside world, e.g. the mains or the like. Preferably, the electrical leads may be embedded in the main base 602 of the corner connector during the manufacturing process, e.g. a molding process, so that a moisture and vacuum tight connection between the first end of the electrical leads inside the inter-pane cavity and the second end of the electrical leads outside inter-pane cavity may be established.

In an embodiment, an electrical connection may be provided between different PV modules, one or more controller modules, sensor modules, and/or electrical leads 608_{1,2} of the spacer structure. In that case, an electrical wiring board 610₁₋₃ may be connected to the main body of the connector module as depicted in FIG. 6B. The main body and the first and second leg of the corner connector may comprise a tilted surface 607₁₋₃ for receiving an electrical wiring board 610₁₋₃. In an embodiment, the electrical wiring board 610₁₋₃ may include one or more printed circuit board (PCB) or a printed wiring board (PCW), mounted on the tilted surfaces 607₁₋₃ of the connector. The printed wiring board may include a (partly) flexible PCB. As shown in the figure, in an embodiment, the electrical wiring board may include a wiring pattern providing an electrical path between first and second electrical leads 608_{1,2} and one or more side connectors 612_{1,2}. In a further embodiment, the electrical wiring board may include a wiring pattern providing an electrical path between a first side connector 612₁ and a second side connector.

The wiring pattern of the electrical wiring board of the corner connector and, optionally the PV modules, may be used to electrically connect PV modules that are positioned at different parts of the spacer structure to a controller module, which is configured to control the power delivery of the PV module and/or sensor modules that are located within the inter-pane cavity. Moreover, the wiring pattern of the electrical wiring board of the corner connector may also be used to connect the output (or in case of data communication the input) of the controller module to the electrical leads that provide a connection to the outside of the inter-pane cavity.

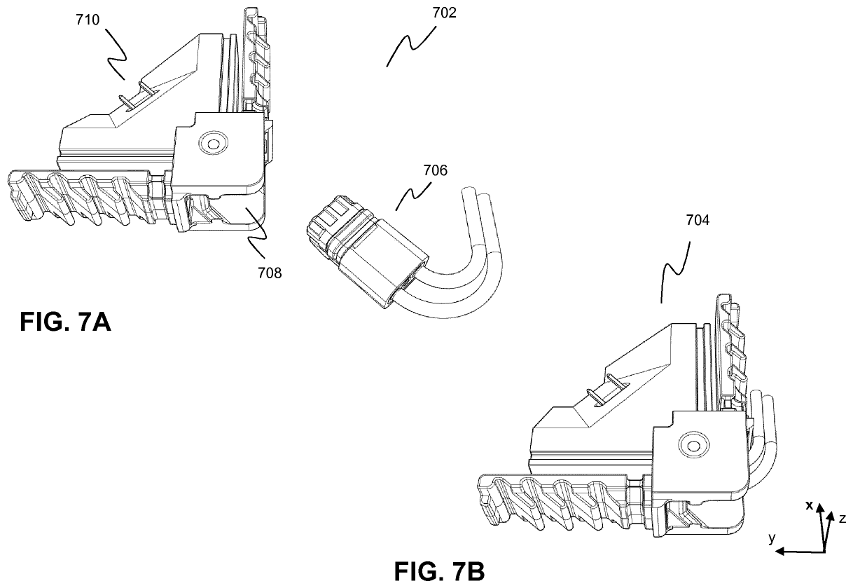

FIGS. 7A and 7B depict a corner connector 702 as described with reference to FIGS. 6A and 6B. These figures illustrate a power plug 706 for connecting the electrical leads 710 to mains. To that end, the corner connector may include a recess 708 for receiving the power plug such that the electrical leads are connected to the mains. As shown in FIG. 7B the power plug may fully fit into the recess such that an assembled multi-pane glazing assembly comprising a power-generating spacer structure may be easily fitted into a window frame.

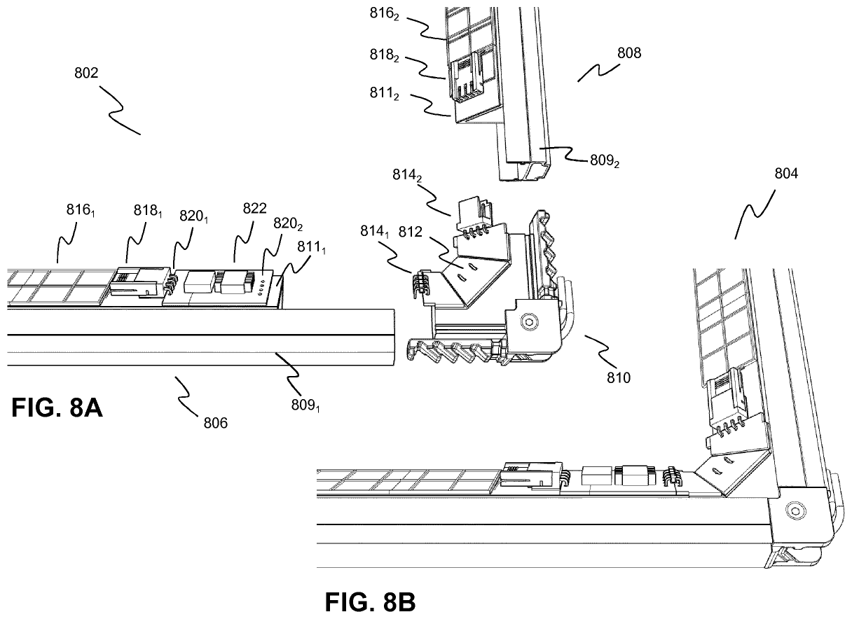

FIGS. 8A and 8B depict part of a modular power-generating spacer structure according to an embodiment of the invention. In particular, FIG. 8A depicts individual parts of a right corner section of a modular power-generating spacer structure 802 in a disassembled state. The right corner section may include two elongated tubular structures 806,808 each comprising a base part 809_{1,2} and a mounting part 809_{1,2} configured to fixate PV modules 816_{1,2} in a tilted position. A PV module may be mounted on a (planar) electrical wiring board, e.g. PCB, including wiring for connecting multiple PV cells in an array. The wiring board of a PV module 816₁ may include a side connector 818₁ (male or female) which is configured to engage with an associated side connector 820₁ (male or female) of a controller module 822. Alternatively, the wiring board of a PV module 816₂ may include a side connector 818₂ (male or female) which is configured to engage with an associated side connector 814₂ (male or female) of the electrical wiring board 812 of the corner connector 810.

The right corner connector 810 may include first and second legs for providing mechanical (sliding) connection with the first and second elongated hollow tubular structures, electrical leads for providing an electrical power connection between PV modules in the inter-pane space via a power plug to mains and an electrical wiring board 812 (e.g. a (partly) flexible PCB) for connecting the electrical leads to the controller 822 and the PV modules 816_{1,2}. To that end, the electrical wiring board may include side connectors 814_{1,2}, wherein each edge connector of the electrical wiring structure is configured to engage with a side connector 820₂ of the controller and/or a side connector 818₂ of a PV module. The side connectors for electrically connecting PV modules to other PV module, to a controller module and/or an electrical wiring board of a corner connection are not limited to the type of connectors depicted in the figures. It will be understood that any type of electrical connector that allows electrical connection of different modules may be used.

FIG. 8B depicts the individual parts of the right corner section 804 of a modular power-generating spacer structure in an assembled state. As shown in this figure, the design of the power-generating spacer structure is highly modular and can be assembled based on slidable mechanical and/or electrical connections in to a power-generating spacer structure. The assembled spacer structure mechanically and electrically tested and characterized before assembly of the multi pane glazing structure.

In an embodiment, instead of the controller module being mounted together with PV modules on the tilted surface, the controller module may also be located within the hollow space of the spacer structure and/or on or in the main body of a corner connector.

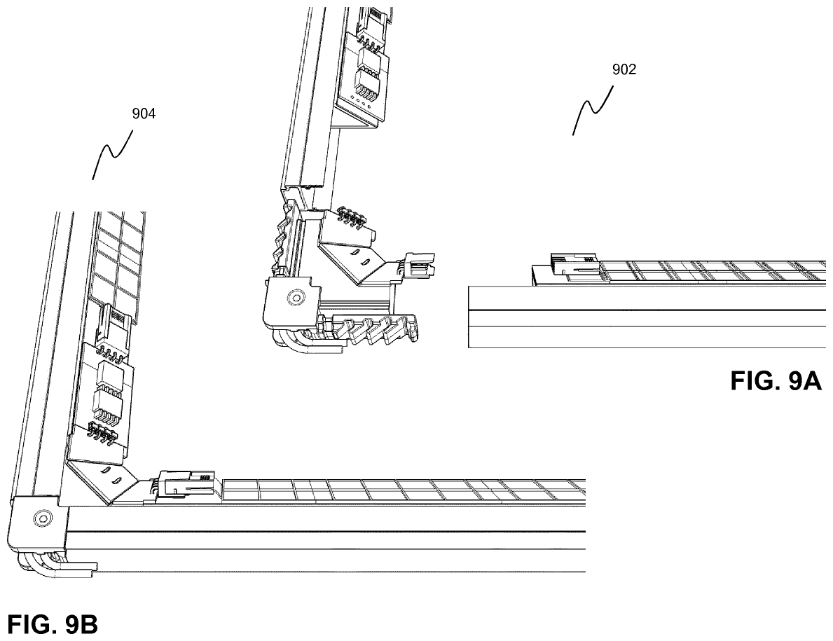

FIGS. 9A and 9B depict part of a modular power-generating peripheral spacer structure according to an embodiment of the invention. These figures show a modular power-generating spacer structure in the disassembled state 902 and assembled state 904 that is similar to the one depicted in FIGS. 8A and 8B, with the exception that in this case, a left corner connector 906 is used as the connection point of the power plug. Due to the modular design and the use of (planar) electrical wiring boards one can chose at what corner of the window assembly the power plug is positioned.

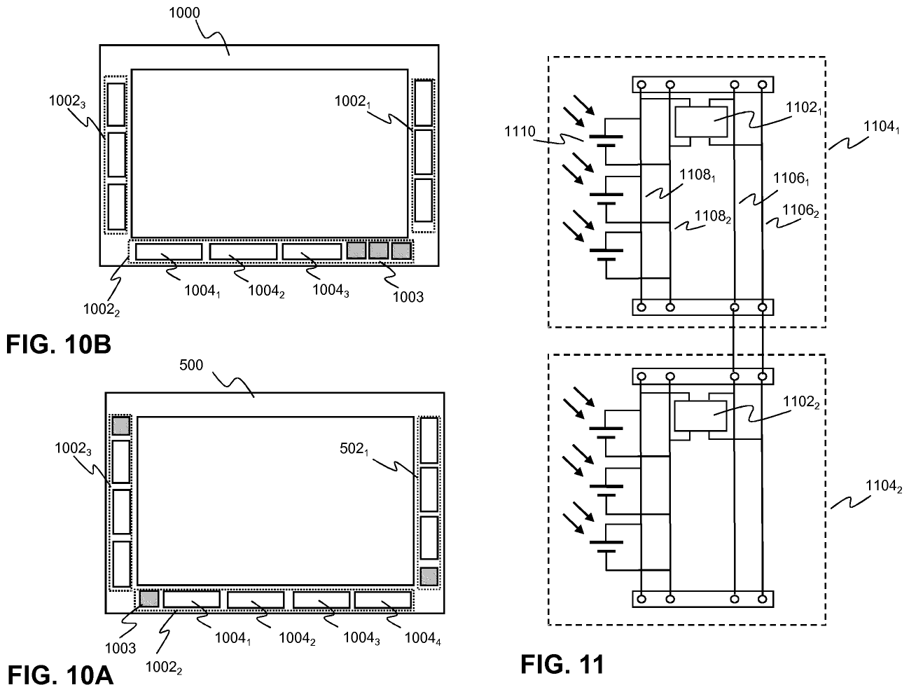

FIGS. 10A and 10B depict schematics of power-generating glazing assemblies controlled by maximum power point tracking modules according to various embodiments of the invention. The glazing assembly may include one or more tilted PV cell modules mounted on a spacer structure arranged around the edges, in particular the lower horizontal edge 1002₂ and the vertical edges 1002_{1,3}, of a multi-pane window assembly. A set of PV cell modules that are arranged along an edge of the window structure may be electrically connected to each other. Such set of connected PV cell modules, e.g. PV modules 1004₁₋₃ arranged on the horizontal edge 1002₂ of the window may form a PV array. A PV array may be connected to a (DC/AC) inverter for converting the DC power generated by the PV arrays into an AC power that is suitable for connection to the mains. Further, a PV array such as PV modules 1004₁₋₃ may be controlled by a maximum power point tracking (MPPT) module 1003, which keeps the power transfer of the PV array at a maximum. A known power point tracking scheme may be used to control the PV cell assembly. FIG. 10A depicts a schematic wherein PV modules at an edge of the window are controlled an MPPT module which is located on the same edge as the PV modules. FIG. 10B depicts a schematic wherein the MPPT modules (one module for PV modules at a particular side of the window) are arrange together as one module at one particular location of the spacer structure (e.g. close to the right corner connector as depicted in FIGS. 8A and 8B or located on or in the corner connector as depicted in FIGS. 6A and 6B. Providing the MPPTs close to each other in one module allows resource sharing of by the MPPTs leading to a more energy efficient control of the power-generating window glazing assembly.

FIG. 11 depicts a maximum power point tracking (MPPT) module for controlling a power-generating spacer structure according to an embodiment of the invention. In particular, FIG. 11 depicts a first PV module 1104₁ connected via first and second wiring 1108_{1,2} to a first MPPT and a second PV module 1104₂ connected via first and second wiring to a second MPPT module. In an embodiment, the first and second MPPT may be arranged in a master slave configuration. In such scheme, the first MPPT module (the master) may receive the output of the first PV module and (via the second MPPT module, the slave) the output of the second PV module. Based on these outputs, the first MPPT may determine optimal working points for the first and second PV module and sent the determined working point to the second MPPT module. This way, the performance of each PV array may be maximized.

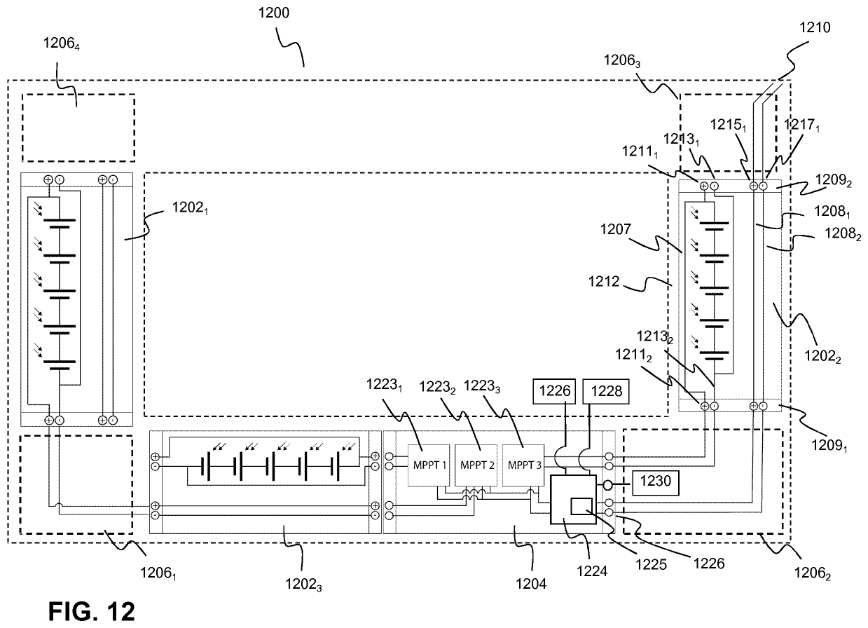

FIG. 12 depicts an electrical wiring scheme for a power-generating spacer structure according to an embodiment of the invention. The figure schematically depicts a power-generating spacer structure 1200, including elongate tubular spacer structures connected by corner connectors 1206₁₋₄, wherein the tubular spacer structures may comprise elongated PV modules 1202₁₋₃, which are arranged on titled position with respect to the (front) window pane. Although FIG. 12 depicts only one PV module at an edge, in practice plurality of PV modules may be arranged in series along the (full) length of an edge of a window. Further, a controller module 1204 may include one or more MPPT modules 1223₁₋₃, a processor 1224 and a powerline communication (PLC) module 1225. Each MPPT module may control the working point of one or more PV modules arranged along a (horizontal or vertical) side of a window. The processor may be configured to control one or more MPPT modules and the PLC module. Additionally, in an embodiment, the processor may control one or more sensor modules 1226,1228,1230 located within the inter-pane spacing and/or in a space of the spacer structure, e.g. a corner connector. Exemplary sensor modules may include temperature, moisture and/or gas sensors.

In an embodiment, the processor of the controller module may receive data from the sensor modules and/or the MPPT modules, (partially) process the data, and forward the data to a powerline communication (PLC) module. The PLC module may subsequently transmit the data via the power line output to another PCL module somewhere in outside power-generating window assembly, which is configured to receive the data and forward the data to a central data processing unit, e.g. a computer or a server in the network.

As shown in FIG. 12, in an embodiment, a PV module 1202 may include a (standardized) electrical wiring board, e.g. a PCB or the like, and a predetermined number of PV cells 1212 mounted on an electrical wiring board. The electrical wiring board may be arranged as an elongated rectangular PCB including a first outer edge 1209₁ and a corresponding second outer edge 1209₂ (the second edge being opposite to the first edge). In an embodiment, the electrical wiring board of the PV module may include an electrical wiring structure 1207 arranged to connect at least part of the PV cells of the PV module in series. Further, in an embodiment, the electrical wiring structure 1207 may include a first PV contact at the first outer edge 1211₁, and a first PV contact at the second outer edge 1211₂, wherein the first PV contacts are connected to the anode side of the series connected PV cells. The electrical wiring structure 1207 may include a second PV contact at the first outer edge 1213₁ and a second PV contact at the second outer edge 1213₂, wherein the second PV contact is connected to the cathode side of the series connected PV cells. Further, the electrical wiring board of the PV module may include first and second electrical bus 1208_{1,2} electrically connecting a third contact at the first outer edge 1215₁ with a third contact at the second outer edge 1215₂ and a second electrical bus 1208₂ may electrically connect a fourth contact at the first outer edge 1217₁ with a fourth contact at the second outer edge 1217₁. Connecting two PV modules comprising a standardized electrical wiring board as depicted in FIG. 12 in series will result in a string of series connected PV cells (e.g. 10 PV cells when each PV module contains 5 PV cells) and two electrical busses.

As shown in FIG. 12, each corner connector 2016₁₋₄ may include a standardized electrical wiring board for electrically connecting the anode and cathode side of series connected PV cells of one or more PV modules to an MPPT module. For example, the electrical wiring board of corner connection 1206₂ may connect the first and second PV contacts (i.e. the anode and cathode side) of PV module 1202₂ to MPPT 1212₃.

The first and second electrical busses on the electrical wiring board of a first PV module may provide a wiring connection to further PV modules and/or to (power) leads of a corner connection that is configured to provide an electrical connection between the PV modules and/or the controller module within the inter-pane cavity and an electrical connector that is configured to provide an electrical power connection to the outside of the glazing assembly. For example, the mains output 1226 of the controller module 1204 may be connected via the wiring of a first corner connection 1206₂ and via the first and second electrical busses of PV module 1202₂ to the wiring of a second corner connection 1206₂ (the upper right corner connection), which comprises electrical leads 1210 for providing an electrical power connection to the outside of the glazing assembly. In a similar way, the first and second electrical busses of PV module 1202₂ and the electrical wiring board of corner connection 1206₁ may prove an electrical connection between the PV cells of PV module 1202₁ and MPPT 1223₂.

As shown in this picture, the standardized wiring board of the PV modules and the wiring boards of the corner connections provide a very flexible wiring scheme for a power-generating spacer structure as described in the embodiments of this application.

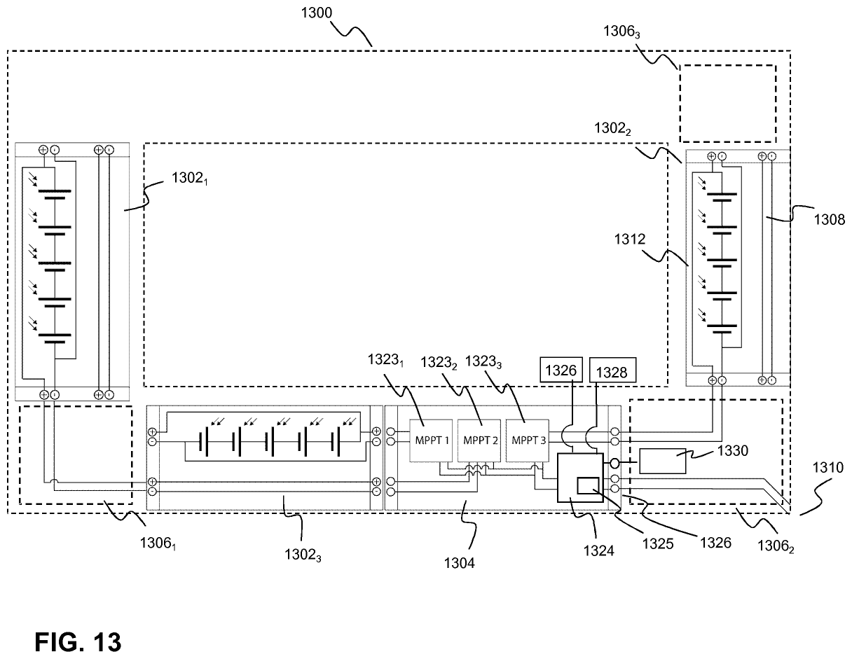

The flexibility provided by the wiring boards of the PV modules and the corner connections is further illustrated in FIG. 13 which depicts an electrical scheme for a modular power-generating spacer structure 1300 according to another embodiment of the invention.

The power-generating spacer structure is similar to the one depicted in spacer structure includes PV modules 1302₁₋₃ arranged at different edges of the window, a controller module 1304 similar to the controller module as described with reference to FIG. 12. In this variant, the right lower corner connector 1306₂ is configured to include electrical leads that provide an electrical power connection to the outside of the glazing assembly. Thus, in that case the electrical wiring board of corner connector 1306₂ may include wiring for connecting the PV cells 1312 of PV module 1302₂ to one of the MPPTs 1323₃ of the controller module 1304. Additionally, the electrical wiring board of the corner connector 1306₂ may include wiring for connecting the mains output 1326 of the controller module 1304 to electrical leads 1310 of the corner connector which provide an electrical power connection to the outside of the glazing assembly. In that case, the first and second electrical busses 1308 of PV module are not used.

Thus, as illustrated by FIGS. 12 and 13, the electrical wiring board of the PV modules including an electrical wiring structure arranged to provide a series connection of the PV cells of the PV module and to provide connection contacts at a first edge of the electrical wiring board and at connection contacts at a second edge of the electrical wiring board, the first edge being opposite to the second edge, wherein the connection contacts include a first contact connected to the anode side of the series connected PV cells and a second contact connected to the cathode side of the series connected PV cells, the connection contact further include at least two connection busses, the first connection bus providing an electrical connection between a third connection contact at the first edge and a third connection contact at the second edge and the second connection bus providing an electrical connection between a fourth connection contact at the first edge and a fourth connection contact at the second edge. Such wiring layout is particular advantageous for connecting different PV modules to one controller module located somewhere along the periphery of the spacer structure.

In an embodiment, each PV array that is arranged along an edge of the glazing assembly may be controlled using a separate multi-point power tracking (MPPT) module. In an embodiment, a MPPT module may be provided as a separate electronic element arranged on the spacer structure or may be provided as an electronic component of a controller module that is configured to control the PV modules. Alternatively, the MPPT may be provided as an electronic component on one or more PV modules. The use of separate MPPT modules for each PV array may provide a substantial advantage in terms of conversion performance.

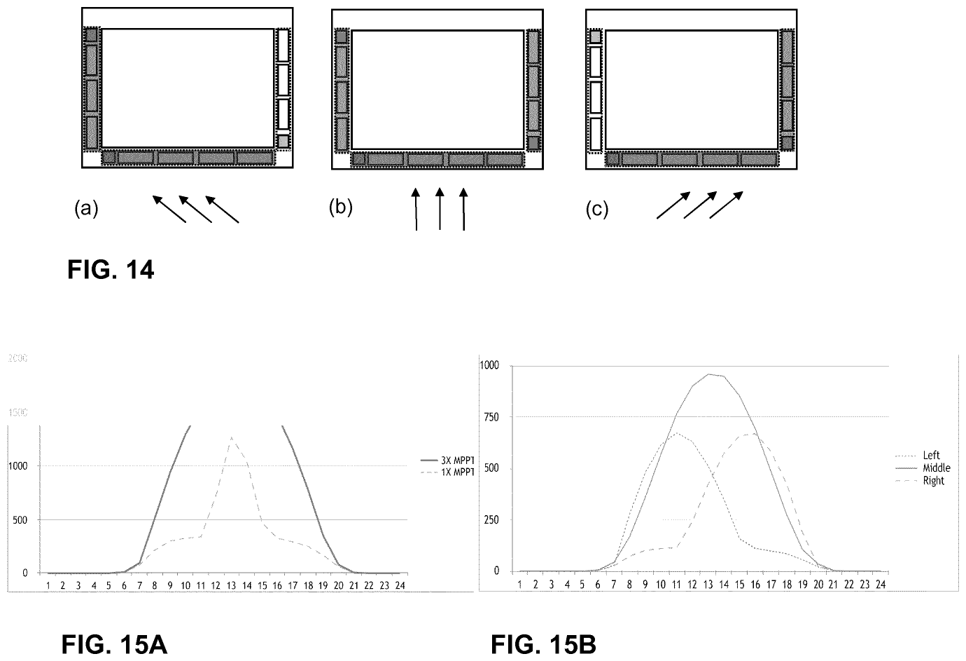

This is schematically illustrated in FIGS. 14 and 14. FIG. 14A-14C depict an example of an exposure of a power-generating window structure including three PV arrays along the edges of the glazing assembly. As shown in this figure, in the morning (FIG. 14A) one vertical PV array will be fully exposed to the solar radiation while the other vertical PV array will be in the shade. Further, the horizontal PV array will be exposed to the solar radiation, but due to the position of the sun, its exposure will be less optimal. Then at noon, both vertical PV arrays and the horizontal PV array may be exposed to approximate the same solar radiation intensity (FIG. 14B). Finally, in the evening a situation that is opposite to the morning may occur, i.e. high exposure of the right horizontal PV array, average exposure of the horizontal PV array and the left vertical PV array may be in the shade (FIG. 14C). Hence, at different time instances during the day, each of the PV array may be exposed differently to the solar radiation. Obviously, FIG. 14 illustrates one particular exposure situation. Many different exposures may occur depending on the orientation of the glazing window.

FIGS. 15A and 15B illustrates the performance of differently controlled power-generating window structures. The graph in FIG. 15A shows the performance of a glazing assembly comprising three vertically and horizontally arranged PV arrays. The dotted lines illustrate the performance of a glazing assembly wherein the three PV arrays are controlled by one central MPPT module. The continuous line illustrates the performance when each of the three PV arrays are controlled by a separate MPPT module. A substantial improvement is shown when using separate MPPT modules for each PV array.

FIG. 15B illustrates the contributions of the individual PV arrays wherein each PV array is controlled by a MPPT module. As shown in this graph, the contributions of the two vertical PV arrays will strongly depend on the orientation of the sun, while the horizontally oriented PV array is less sensitive to the orientation of the sun. Therefore, thus of a separate MPPT for PV modules arranged at a particular side of the window will greatly enhance the overall power production of the power-generating glazing assemblies described in this application.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. Glazing assembly comprising:
at least a first, inner glass pane, a second, outer glass pane and at least one spacer structure for providing a predetermined separation between the first and second glass panes, the spacer structure being positioned at a peripheral area of the first and second glass panes;
one or more photovoltaic (PV) modules mounted on and/or in at least part of the spacer structure, the one or more PV modules being positioned in an inter-pane cavity defined by the first and second glass panes and the spacer structure;
wherein at least part of the spacer structure comprises one or more mounting members adapted to orient a light receiving surface of PV cells of the one or more PV modules in a tilted position with respect to the plane of the second, outer glass pane; and,
the spacer structure comprises one or more elongated members, each of said one or more elongated members having a cross-sectional profile, the cross-sectional profile defining a hollow body part and a mounting part, the mounting part comprising one or more fastening members for removably mounting the one or more PV cell modules on at least part of the spacer structure, wherein
the one or more fastening members comprise a sliding mechanism, a clamping mechanism or a sliding and clamping mechanism.

2. The glazing assembly according to claim 1, wherein the light receiving surface of the one or more PV modules and a surface of the first or second pane define a tilt angle between 10 and 80 degrees.

3. The glazing assembly according to claim 1, wherein the mounting part is configured to orient the one or more PV modules in a fixed tilted position.

4. The glazing assembly according to claim 1, wherein the spacer structure further comprises a first elongated member for fixating a first of said one or more PV modules in a first titled position, a second elongated member for fixating a second of said one or more PV modules in a second titled position and a corner connection for mechanically connecting a first end of the first elongated member to a first end of the second elongated member.

5. The glazing assembly according to claim 4, wherein the corner connection further comprises at least one electrical wiring structure that is arranged to electrically connect the first of said one or more PV modules mounted on the first elongated member to a controller module; and/or, wherein the at least one electrical wiring structure comprises electrical leads embedded in a main body of the corner connector, a first end of the electrical leads forming a first power connector in the inter-pane cavity of the glazing assembly and a second end of the electrical leads forming a second power connector outside the inter-pane cavity.

6. The glazing assembly according to claim 1, wherein the spacer structure comprises a first bonding surface bonded against the first inner glass pane and a second bonding surface bonded against the second outer glass pane, the spacer structure forming or being part of a seal along the peripheral part of the first and second glass panes, the seal sealing the inter-pane cavity between the first and second glass panes.

7. The glazing assembly according to claim 1, wherein the second outer glass pane includes a central window area which is transparent for solar light from a visible part of the spectrum and which reflects at least part of the near infrared part of the solar spectrum and a peripheral area around the central window area, the peripheral area defining a solar cell light entrance area for exposing the PV cells to solar light from the visible and the near infrared parts of the spectrum.

8.The glazing assembly according to claim 1, wherein at least part of the one or more PV modules comprises an elongated shaped electrical wiring board comprising a first outer edge and an opposite second outer edge, the electrical wiring board including an electrical wiring structure arranged to electrically connect at least part of the PV cells of the one or more PV modules in series.

9. The glazing assembly according to claim 8, wherein the electrical wiring structure further includes a first PV contact at the first outer edge and a first PV contact at the second outer edge, the first PV contacts are connected to an anode side of said PV cells connected in series, the electrical wiring structure includes a second PV contact at the first outer edge and a second PV contact at the second outer edge, the second PV contacts are connected to a cathode side of the PV cells connected in series, and the electrical wiring board of the PV module further comprises a first electrical bus and a second electrical bus, the first electrical bus electrically connecting a third contact at the first outer edge with a third contact at the second outer edge and the second electrical bus electrically connecting a fourth contact at the first outer edge with a fourth contact at the second outer edge.

10. The glazing assembly according to any of claims 1-9 wherein the first PV modules arranged on a first part of the spacer structure along a first edge of a window pane are electrically connected to each other, the electrically connected first PV modules forming a first PV array; and, wherein second PV modules arranged on a first part of the spacer structure along a second edge of a window pane are electrically connected to each other, the electrically connected second PV modules forming a second PV array, and at least two maximum power point tracking (MPPT) devices are arranged on the first part of the spacer structure, the first MPPT device being connected to the first PV array and the second MPPT device being connected to the second PV array.

11. Glazing assembly comprising:
at least a first, inner glass pane, a second, outer glass pane and at least one peripheral spacer structure for providing a predetermined separation between the first and second glass panes;
a plurality of elongated photovoltaic (PV) cell modules positioned along one or more edges of the first and second glass panes, a light receiving surface of PV cells of the plurality of PV cell modules and a plane of the second, outer glass pane defining a tilt angle of between 10 and 80 degrees;
wherein the PV cell modules positioned along a first said edge of the first and second glass panes are connected to a first maximum power point tracking (MPPT) device and the PV cell modules positioned along a second said edge of the first and second glass panes are connected to a second maximum power point tracking (MPPT) device.

12. The glazing assembly according to claim 11, wherein the first and second maximum power point tracking (MPPT) devices are positioned along the first edge of the first and second glass panes.

13. Power-generating spacer structure for a power-generating glazing assembly comprising:
one or more photovoltaic (PV) modules mounted on and/or in at least part of a spacer structure for a glazing assembly comprising first and second glass panes, the one or more PV modules being positioned in an inter-pane cavity defined by the first and second glass panes and the spacer structure;
wherein at least part of the spacer structure comprises one or more mounting members adapted to orient a light receiving surface of PV cells of the PV modules in a tilted position with respect to the plane of the second (outer) glass pane; and,
wherein the spacer structure comprises one or more elongated members, each said elongated member having a cross-sectional profile, the cross-sectional profile defining a hollow body part and a mounting part, the mounting part comprising one or more fastening members for removably mounting the one or more PV cell modules on at least part of the spacer structure, wherein
the fastening members comprise a sliding mechanism, a clamping mechanism or a sliding and clamping, mechanism.

14. The spacer structure according to claim 13 wherein the light receiving surface of the PV cells of the one or more PV modules and the surface of the first or second pane define a tilt angle between 10 and 80 degrees.

15. The spacer structure according to claim 13, wherein the mounting part is configured to orient the one or more PV modules in a fixed tilted position.

16. The spacer structure according to claim 13, wherein the spacer structure further comprises a first elongated member for fixating a first of said one or more PV modules in a first titled position, a second elongated member for fixating a second of said one or more PV modules in a second titled position and a corner connection for mechanically connecting a first end of the first elongated member to a first end of the second elongated member.

17. The spacer structure according to 16, wherein the corner connection further comprises at least one electrical wiring structure, wherein the at least one electrical wiring structure is arranged to electrically connect one of the first of said one or more PV modules mounted on the first elongated member to a controller module.

18. The spacer structure according to claim 13, wherein at least part of the one or more PV modules comprises an elongated shaped electrical wiring board comprising a first outer edge and an opposite second outer edge, the electrical wiring board including an electrical wiring structure arranged to electrically connect at least part of the PV cells of the one or more PV modules in series.

19. The spacer structure according to claim 18 wherein the electrical wiring structure further includes a first PV contact at the first outer edge and a first PV contact at the second outer edge, wherein the first PV contacts are connected to an anode side of the PV cells connected in series and wherein the electrical wiring structure includes a second PV contact at the first outer edge and a second PV contact at the second outer edge, wherein the second PV contact is connected to a cathode side of the PV cells connected in series, the electrical wiring board of the one or more PV modules further comprises a first electrical bus and a second electrical bus, the first electrical bus electrically connecting a third contact at the first outer edge with a third contact at the second outer edge and the second electrical bus electrically connecting a fourth contact at the first outer edge with a fourth contact at the second outer edge.

20. The spacer structure according to claim 13, wherein first of said one or more PV modules that are arranged on a first part of the spacer structure along a first edge of a window pane are electrically connected to each other, the electrically connected first of said one or more PV modules forming a first PV array; and, wherein second of said one or more PV modules that are arranged on a first part of the spacer structure along a second edge of a window pane are electrically connected to each other, the electrically connected second of said one or more PV modules forming a second PV array, at least two maximum power point tracking (MPPT) devices arranged on the first part of the spacer structure, the first MPPT device being connected to the first PV array and the second MPPT device being connected to the second PV array.

21. A corner connection for a spacer structure comprising:
a main body connected to a first end portion and a second end portion, the first end portion comprising at least a first leg which is shaped to engage with a first end of a part of the spacer structure to provide a first mechanical connection with the first part of the spacer structure; and, the second end portion comprising at least a second leg which is shaped to engage with a first end of a second part of the spacer structure to provide a second mechanical connection with the second part of the spacer structure; and
at least one electrical wiring structure, the wiring structure comprising one or more printed circuit boards mounted on the main body; and, the wiring structure comprising electrical power leads embedded in the main body of the corer connector, a first end of the electrical leads forming a first power connector in an inter-pane cavity of a glazing assembly and a second end of the electrical leads forming a second power connector outside the inter-pane cavity of the glazing assembly;
wherein an electrical path of the one or more printed circuit boards or printed wiring boards of the glazing assembly is in electrical contact with the electrical power leads.

22. The corner connection according to claim 21, comprising a moisture and vacuum tight connection between the first end of the electrical leads inside the inter-pane cavity of the glazing assembly and the second end of the electrical leads outside the inter-pane cavity of the glazing assembly.

23. The corner connection according to claim 22, wherein the moisture and vacuum tight connection is obtainable by embedding the electrical leads in the main body during a molding process.
